(19) United States
(12) Patent Application Publication
(10) Pub. No.: US 2026/0264197 A1
(43) Pub. Date: Sep. 10, 2026

(54) TOOL FOR HANDLING HAZARDOUS WASTE

(71) Applicant: VANDERBILT UNIVERSITY, Nashville, TN (US)

(72) Inventors: Kevin C. GALLOWAY, Nashville, TN (US); Angelica PARKER, Nashville, TN (US); Kaelon MCNEECE, Nashville, TN (US)

(21) Appl. No.: 19/500,527

(22) PCT Filed: Jul. 17, 2024
(86) PCT No.: PCT/US2024/038283

§ 371 Date: Jan. 8, 2026

Related U.S. Application Data
(60) Provisional application No. 63/527,355, filed on Jul. 18, 2023.

(51) Int. Cl. B25B 9/02; E04H 17/26

(52) U.S. Cl. CPC B25B 9/02; E04H 17/268

(57) ABSTRACT

Various embodiments of a device for handling hazardous wire are provided. A device for handling hazardous wire can include an end effector portion configured to contact hazardous wire. The end effector portion can include a rear facing hook and a front facing hook. The device can further include a handle suitable to grasp the tool. Finally, the device can include an elongated rod extending along an axis from the handle at a proximal end to the end effector at the distal end.

### CROSS-REFERENCE TO RELATED APPLICATION

This application claims priority to, and the benefit of, U.S. Provisional Patent Application 63/527,355 entitled “TOOL FOR HANDLING HAZARDOUS WIRE” which was filed on Jul. 18, 2023, and is incorporated by reference as if set forth herein in its entirety.

### STATEMENT OF GOVERNMENT SUPPORT

This invention was made with government support under grant/contract number W911NF2120078 awarded by the US Army. The government has certain rights in the invention.

### BACKGROUND

Concertina wire (C-wire) is a proven defensive measure to secure an operating base from external threats, however, it's effectiveness also presents hazards to the operator during emplacement and displacement. Emplacing and displacing C-wire is a manual process that requires operators to carry C-wire bundles to and from a loading vehicle, extend and collapse spools, detangle spools, and lift sections overhead to place over or clear pickets all while wearing over 50 pounds of body armor, assigned weapon, and ammunition. This process is repeated for each 15-yards section along perimeters ranging from hundreds of yards to miles. The handling of the C-wire is severely constrained due to the barbed edges catching on Soldiers' gear often causing injury and destruction of equipment. Hence it is difficult to move quickly when handling C-wire, making it a time-consuming and unnecessarily exhausting process.

### SUMMARY

In accordance with the purpose(s) of this disclosure, as embodied and broadly described herein, the disclosure, in various aspects, relates to devices for handling hazardous wire and methods of use thereof.

Embodiments of the present disclosure include a device for handling hazardous wire having an end effector portion configured to contact hazardous wire. The end effector portion can include a rear facing hook and a front facing hook. The device can further include a handle suitable to grasp the tool. Finally, the device can include an elongated rod extending along an axis from the handle at a proximal end to the end effector at the distal end.

The device can further include an adjustable backstop coupled to the elongated rod between the end effector portion and the handle portion, where the backstop is configured to be adjustably positioned along at least a portion of the length of the elongated rod. In some examples, the backstop can be rotatable about the elongated rod. The elongated rod can have an adjustable length or be telescoping. In some examples, the elongated rod is foldable. The handle can be positioned at an angle relative to the axis of the elongated rod. The handle portion can comprise a forearm cuff positioned proximal to the handle.

According to various examples, the end effector further includes a notch feature incorporated into at least one of the rear facing hook or the front facing hook. Additionally, the end effector can further include a moveable lever to open or close at least one of the rear facing hook or the front facing hook, where the moveable lever is operable by a user from the handle portion. In some embodiments, the rear facing hook and the front facing hook form an S-shape. However, in some embodiments, the rear facing hook and the front facing hook form a C-shape. The end effector can also be removeable, and the device can further include a connector portion suitable to secure the removeable end effector to the elongated rod. In some examples, the elongated rod comprises a metal or composite material.

The device can also include a backstop that extends circumferentially around the elongated rod. The handle can extend along the axis of the elongated rod. In some examples, the backstop is connected to the handle by an arch-like structure.

Similarly, a wire-handling tool is provided, where the tool includes an elongated rod having a proximal end and a distal end, an end effector connected to the elongated rod at the distal end, and a backstop disposed on the elongated rod proximal to the end effector. The end effector can comprise a rear facing hook and a front facing hook, and the backstop can be configured to shield a handle disposed near the proximal end of the elongated rod. In some examples, the backstop is configured in a frustum shape, where a larger end of the frustum shape is proximal to the narrower end. In some examples, the end effector is detachably attached to the distal end of the elongated rod.

According to various examples, a wire-handling tool can include an elongated rod having a proximal end and a distal end, an end effector connected to the elongated rod at the distal end, a backstop disposed on the elongated rod proximal to the end effector, and a handle disposed on the elongated rod proximal to the backstop. The end effector can include a rear facing hook and a front facing hook. The handle can be connected to the backstop by an arched member.

Other systems, methods, devices, features, and advantages of the devices and methods will be or become apparent to one with skill in the art upon examination of the following drawings and detailed description. It is intended that all such additional systems, methods, devices, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-C are illustrations of example tools according to various embodiments of the present disclosure.

FIGS. 2A-E are illustrations of various views of the tool according to various embodiments of the present disclosure.

FIGS. 3-6 are illustrations of the tool in various uses according to various embodiments of the present disclosure.

FIG. 7-9 are illustrations of example tools according to various embodiments of the present disclosure.

FIG. 10 is an illustration of an example tool being worn on a operator according to various embodiments of the present disclosure.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth to provide those of ordinary skill in the art with a complete disclosure and description of how to perform the methods and use the compositions and compounds disclosed and claimed herein. Efforts have been made to ensure accuracy with respect to numbers (e.g., amounts, measurements, etc.), but some errors and deviations should be accounted for.

Before the embodiments of the present disclosure are described in detail, it is to be understood that, unless otherwise indicated, the present disclosure is not limited to particular materials, machines, computing processes, or the like, as such can vary. It is also to be understood that the terminology used herein is for purposes of describing particular embodiments only and is not intended to be limiting. It is also possible in the present disclosure that steps can be executed in different sequence where this is logically possible.

All publications and patents cited in this specification are cited to disclose and describe the methods and/or materials in connection with which the publications are cited. Publications and patents that are incorporated by reference, where noted, are incorporated by reference as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. Any terms not specifically defined within the instant application, including terms of art, are interpreted as would be understood by one of ordinary skill in the relevant art; thus, is not intended for any such terms to be defined by a lexicographical definition in any cited art, whether or not incorporated by reference herein, including but not limited to, published patents and patent applications. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

It should be noted that ratios, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Discussion

Various embodiments of devices and methods for handling hazardous wire are described. The device or tool for handling hazardous wire, such as C-wire, has several features to improve the process of emplacing and displacing concertina wire and difficult to handle wire materials in general. The main tasks of emplacing and displacing C-wire can be broken into moving C-wire bundles into position, pulling on the ends of the coil to expand or unbundle it, lifting sections over pickets, detangling sections, and finally re-bundling C-wire for displacement. The proposed tools and sub-components are designed to address all of these tasks or specific tasks, respectively.

The current primary solution for handling C-wire is the use of Barbed Wire Handler's (BWH) gloves made of thick leather with staples lining the palmar side. These gloves protect the hands while handling C-wire; however, they present several operational challenges including poor fit, snagging on the C-wire which increases the frustration level of the task and risk of injury, limited protection for tasks such as reaching into C-wire coils to release tangles, and a lack of durability when the BWH gloves are exposed to the elements. The short shelf-life often means operators do not have enough BWH gloves to emplace or displace the C-wire.

Accordingly, various embodiments of the present disclosure provide for a device or tool for handling hazardous wire. In non-limiting examples, the device for handling hazardous wire is described for use with C-wire, although the device can be relied upon to handle other hazardous wires or material, as well as for other purposes.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

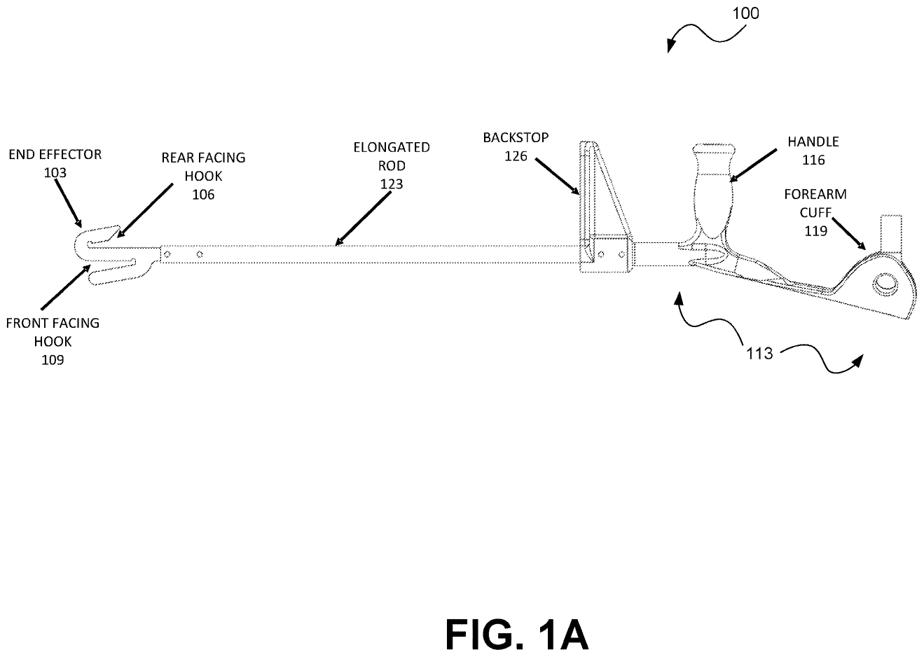

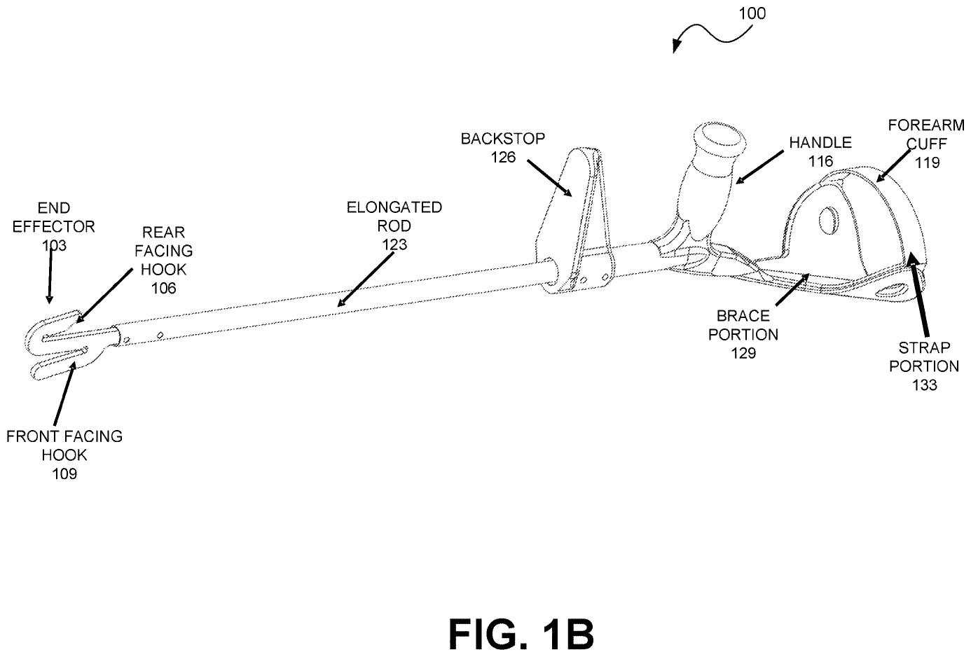

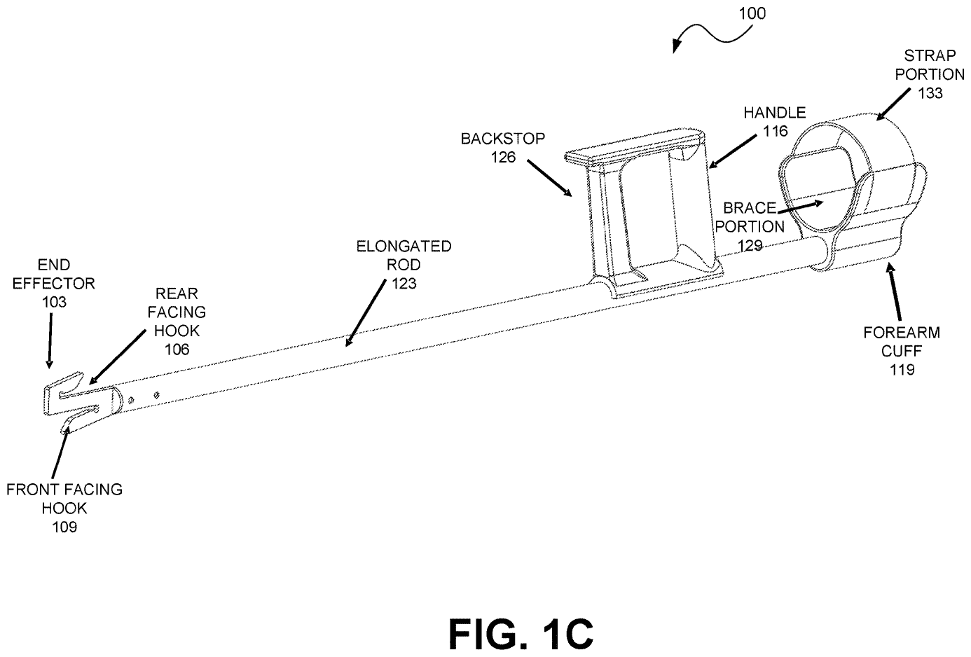

Beginning with FIGS. 1A-C, shown are three different views of the wire-handling tool 100 according to various embodiments. The wire-handling tool 100 include an end effector 103 configured to contact hazardous wire. The end effector 103 may include a rear facing hook 106 and a front facing hook 109. The wire-handling tool 100 also includes a handle portion 113 including a handle 116 suitable to grasp the wire-handling tool 100 and a forearm cuff 119. In addition, the wire-handling tool 100 can include an elongated rod 123 having a length. The elongated rod 123 can extend along an axis from the handle portion 113 at a proximal end to an end effector 103 at the distal end. The wire-handling tool 100 can include an adjustable backstop 126 coupled to the elongated rod 123 between the end effector 103 and the handle portion 113, where the backstop 126 is configured to be adjustably positioned along at least a portion of the length of the elongated rod 123. In some embodiments, the backstop 126 can be rotatable about the elongated rod 123. The elongated rod 123 can have an adjustable length, be telescoping, foldable, or adjustable in various other manners.

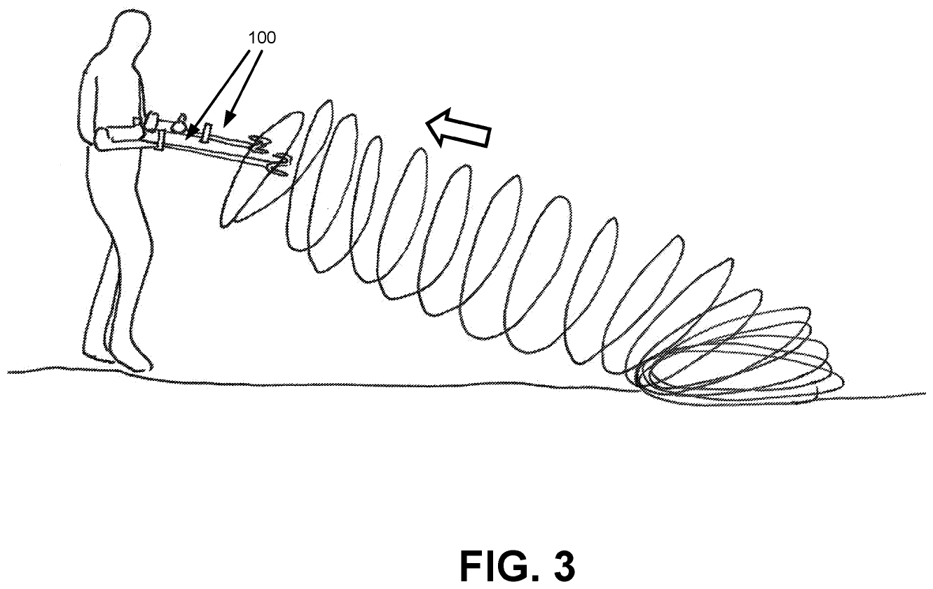

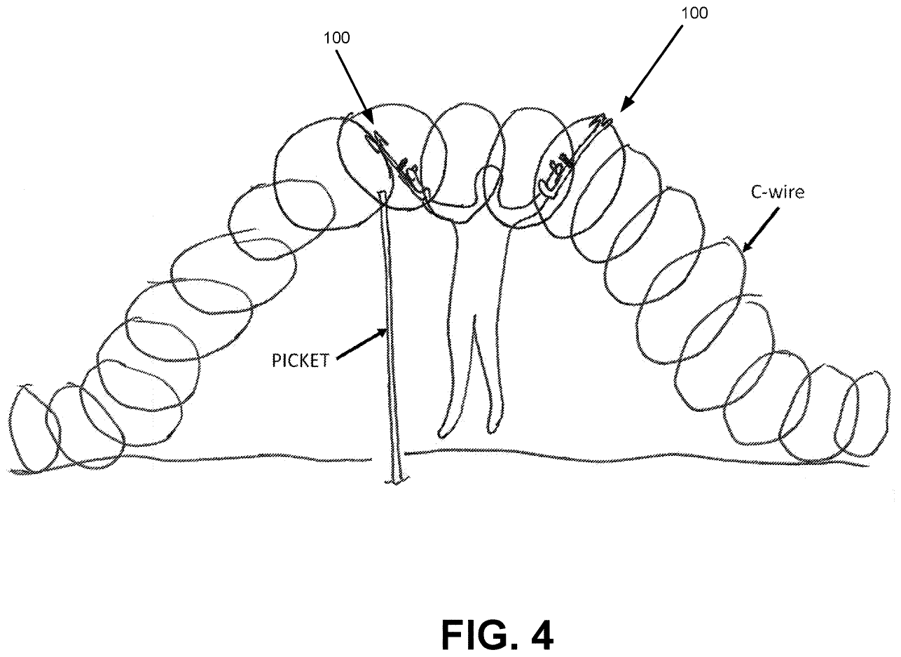

FIG. 1A presents a wire-handling tool 100 with an end effector 103 with a rear facing hook 106 for pulling on hazardous wire (see FIG. 3) and front facing hook 109 primarily for lifting hazardous wire. The elongated rod 123 creates a safe stand-off distance between the operator and the hazardous wire. The elongated rod 123 also extends the reach of the operator to 1) grab the wire without leaning over, 2) strike, pull, or pry tangled sections, and 3) facilitate lifting the wire over pickets (see FIG. 4). When the hazardous wire must be collapsed or re-bundled, the elongated rod 123 can be passed through the inner area of the wire coil up to the backstop 126 (see FIG. 5). The elongated rod 123 and backstop 126 help the operator constrain the coil to safely and efficiently re-bundle the wire without placing a hand on the coil. The backstop 126 can rotate around the elongated rod 123 to different orientations as well as be set to different positions along the length of the elongated rod 123. Additionally, the backstop 126 can fold inward for packing to a lower profile.

The elongated rod 123 can also be fixed length or adjustable length through means such as telescoping. The elongated rod 123 can also be foldable for storage. The elongated rod 123 can be made from a variety of materials including steel, aluminum, wood and composites such as fiberglass or carbon fiber. FIG. 1A also depicts the handle 116 and forearm cuff 119 which is how the operator controls the wire-handling tool 100. While one embodiment of the end effector 103 is presented here, the end effectors 103 can be swappable for replacement purposes or with a completely different design to enable new capabilities.

FIG. 1B presents a 3D view of FIG. 1A. As shown in FIG. 1B, the forearm cuff 119 can be disposed at a proximal end of the elongated rod 123 and be configured to detachably attach to a operator's forearm. In some examples, the forearm cuff 119 includes a brace portion 129 and a strap portion 133, where the strap portion 133 is adjustable. The brace portion 129 can be configured to contour to the forearm of a operator for comfort in supporting the wire-handling tool 100. The brace portion 129 can be formed from a leather, fabric, foam, or other comfortable material lining a more rigid and supportive material such as plastic, metal, or other material. The strap portion 133 can also be configured to comfortably wrap around a operator's forearm in order to secure the wire-handling tool 100. The strap portion 133 can be adjustable to fit many different sizes of forearms. The strap portion 133 can be formed from a leather, fabric, foam, elastic band, or other comfortable material as can be appreciated. Also shown in FIG. 1B, the wire-handling tool 100 can include a handle 116 which is disposed between the forearm cuff 119 and the backstop 126. The handle 116 can include an ergonomic grip to fit the hand of a operator. The handle 116 can include a padded portion to enhance comfort for the operator. In some embodiments, the handle 116 is at least partially covered in a silicone, rubber, plastic, fabric, or other comfortable material. The backstop 126 can comprise a solid panel connected to the elongated rod 123 in a direction approximately perpendicular to the axis of the elongated rod 123 as shown in FIG. 1B. The backstop 126 can comprise a variety of shapes, including the shape shown in FIG. 1B, the shape shown in FIG. 1C, and many others as can be appreciated. For example, as shown in FIG. 1C, the backstop 126 can be connected with the handle 116 in order to form better protection of the knuckles of the operator.

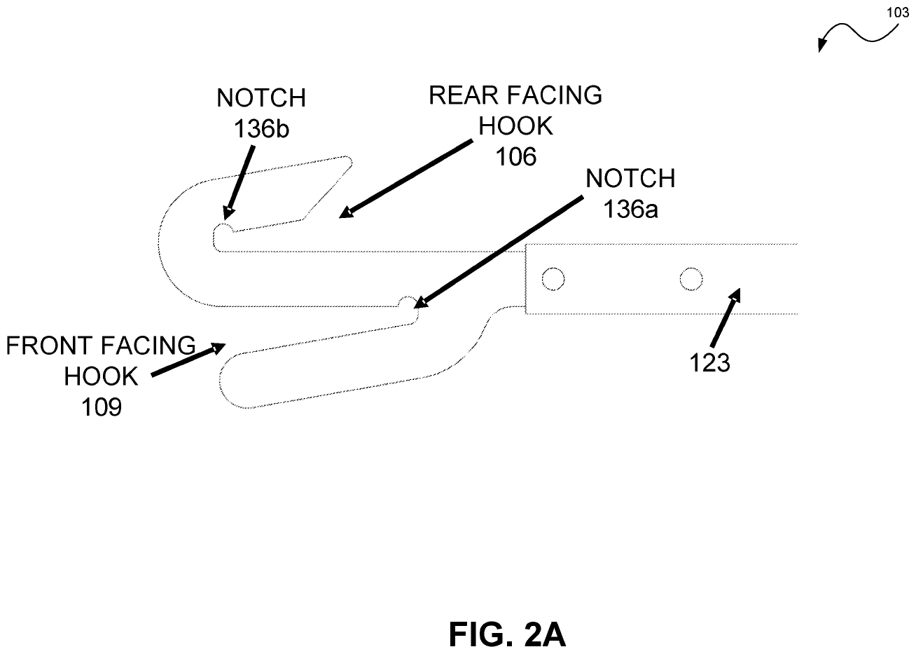

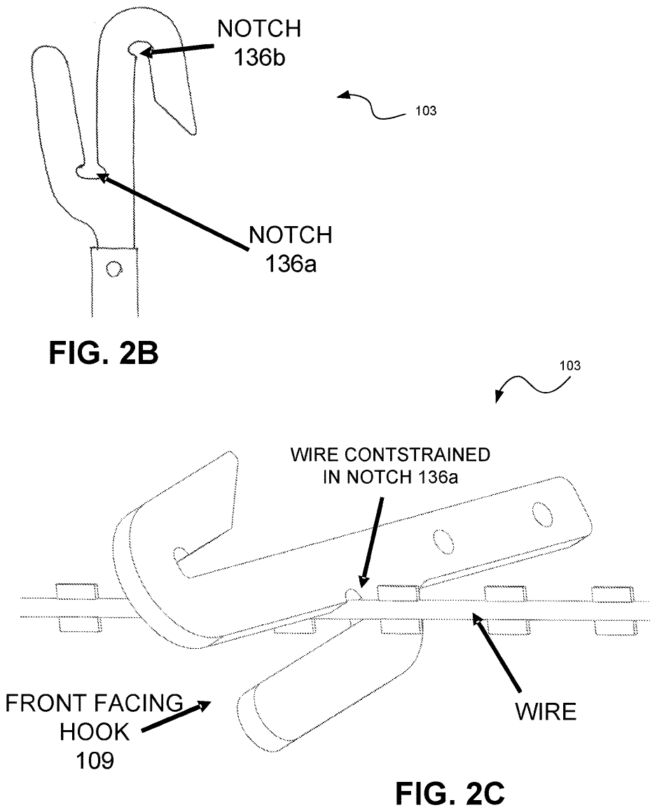

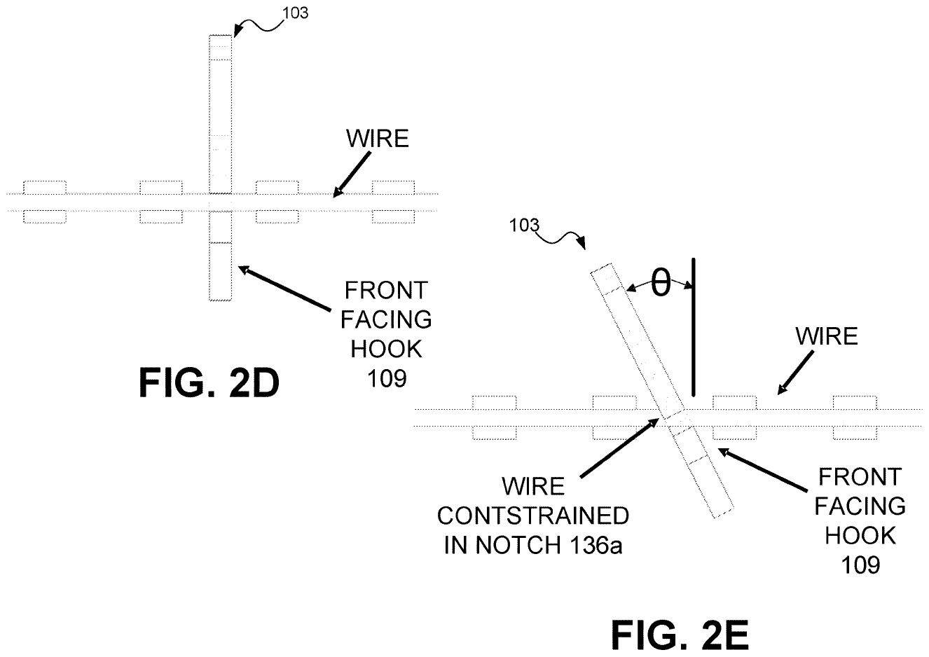

Moving on to FIG. 2A, shown is an example of an end effector 103 of the wire-handling tool 100 according to various embodiments. FIG. 2A depicts a notch 136 that can be incorporated into the front facing hook 109 (notch 136a in FIG. 2A) and/or the rear facing hook 106 (notch 136b). The notches 136a, 136b are depicted on one side of each hook, but could be mirrored (as depicted in FIG. 2B) or take on a completely different shape to help further constrain the wire when it is in the respective hook. The notch 136 can geometrically constrain a wire which is in either the rear facing hook 106 or the front facing hook 109 when the end-effector 103 is rotated about the axis of the elongated rod 123. As shown in FIGS. 2C and 2E, when the elongated rod 123 is rotated about its axis by a number of degrees 0, the notch 136 will fit around the wire so as to constrain the wire from sliding in and out of the respective hook. For example, FIG. 2C shows a three-dimensional view of the end effector 103 with a wire being held in the front facing hook 109. The notch 136a is shown constraining the wire into the front facing hook 109. FIG. 2D depicts a front view of FIG. 2C with the wire disposed in the notch 136a of the front facing hook 109. FIG. 2E depicts the end effector 103 rotated by 0 degrees about the axis of the elongated rod 123 and the portion of the notch 136a blocking the wire from exiting the front facing hook 109. In some embodiments, the angle 0 degrees can be representative of an angle between approximately 0 and 90 degrees, approximately 15 and 45 degrees, approximately 20 and 30 degrees, or another range as can be appreciated. While FIGS. 2C-E depict the wire being secured in the notch 136a of the front facing hook 109, the wire can similarly be constrained in the notch 136b of the rear facing hook 106. In practice, when the operator wants to create an extra hold on the wire, a slight rotation of the forearm will rotate the end effector 103 and lock the wire in the notch 136a.

Turning now to FIG. 3, shown is an example of how the rear facing hooks 106 of two wire-handling tools 100 can be used to grab the end of a wire buddle and pull to unbundle. Note that FIG. 3 depicts two wire-handling tools 100 being used by the operator. In some examples, the use of more than one wire-handling tool 100 can make it easier to handle the wire and keep it balanced. However, in some examples, an operator can handle the wire with one wire-handling tool 100.

Moving to FIG. 4, shown is another illustration demonstrating the use of wire-handling tools 100 in placing hazardous wire. FIG. 4 depicts the front facing hooks 109 of two wire-handling tools 100 being used to lift hazardous wire over a picket for placement.

In FIG. 5, shown is an illustration demonstrating the use of a wire-handling tool 100. An operator can use the backstop 126 of the wire-handling tool 100 in combination with the elongated rod 123 to push a hazardous wire back into a coil formation. The backstop 126 can prevent the hazardous wire from hitting the hand of the operator.

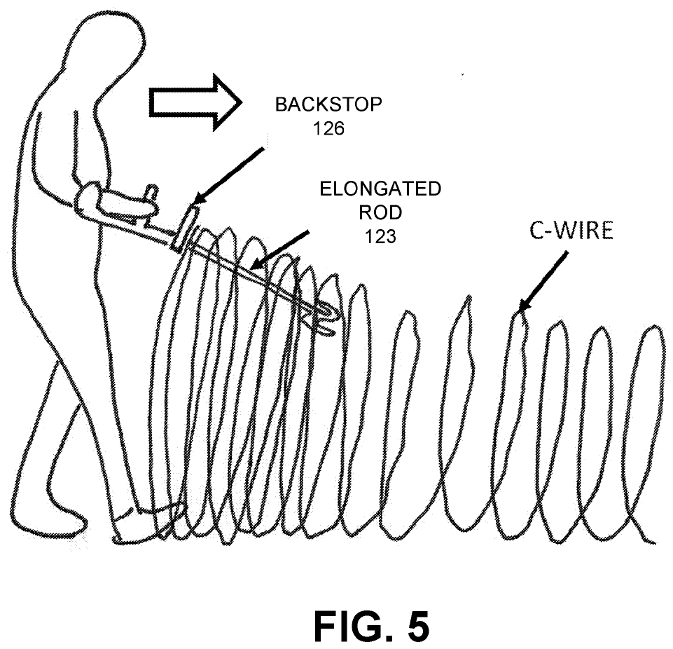

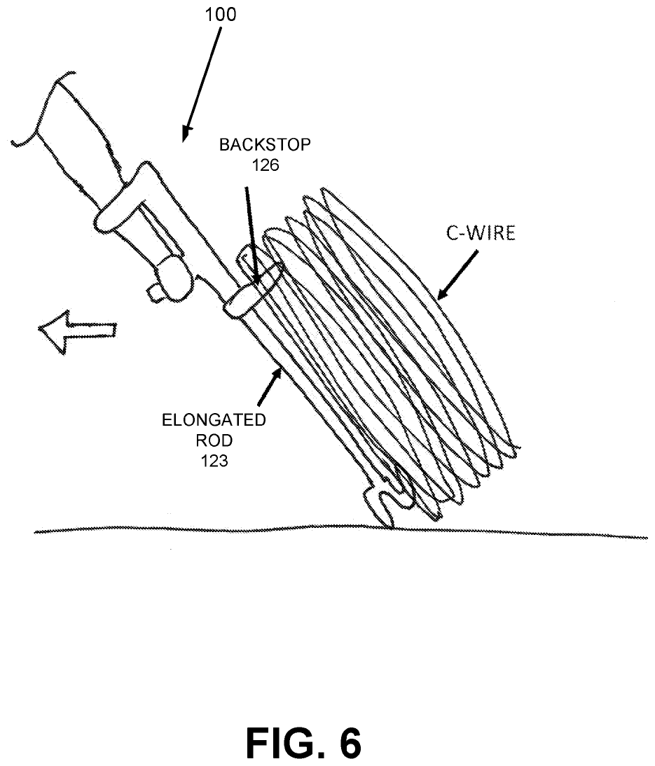

FIG. 6 shows another example use of the wire-handling tool 100. As previously mentioned, the backstop 126 can be rotatable around the axis of the elongated rod 123. In some cases, the backstop 126 can be rotated to a side of the elongated rod 123 opposite the handle, as shown in FIG. 6. The backstop 126 can then be used to hook a coil of hazardous wire and drag the wire away from the body of the operator.

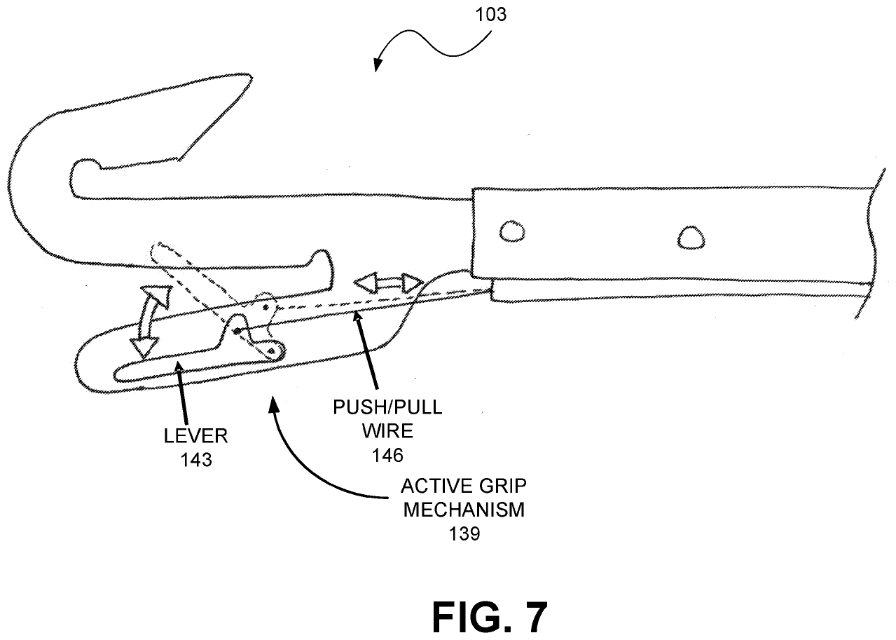

Next, at FIG. 7, shown is an example embodiment of an end effector 103 having an active grip mechanism 139. The active grip mechanism 139 can allow an operator to lock a wire into one of the rear facing hook 106 or the front facing hook 109. In some embodiments, the active grip mechanism 139 can consist of a lever 143 and a push/pull wire 146 which can be connected to a trigger mechanism near the handle 116. The push/pull wire 146 can operate the lever 143 of the hook to open or close the hook. In some examples, the active grip mechanism 139 can comprise another type of gripping mechanism such as a jaw gripper, parallel gripper, etc.

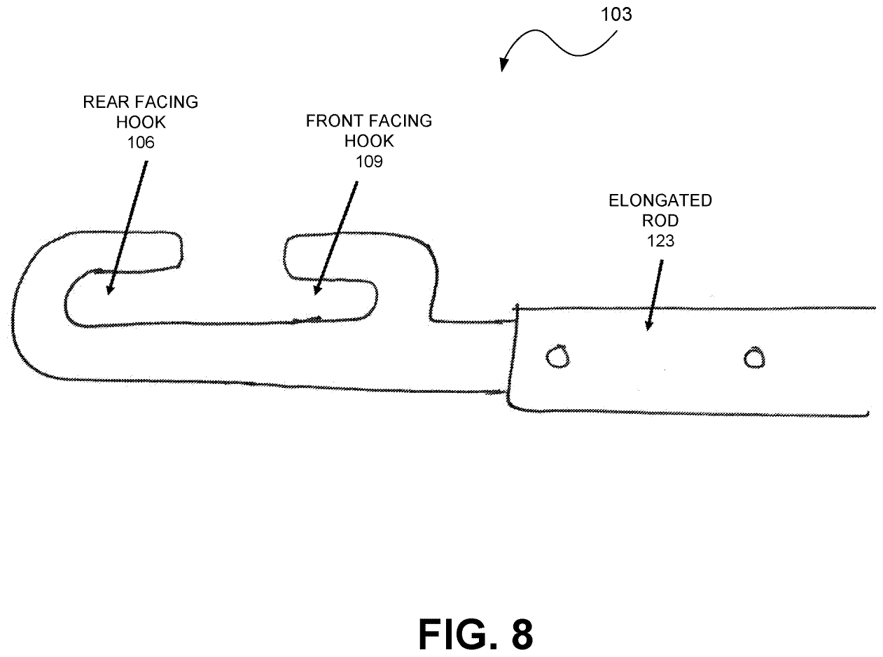

FIG. 8 shows an illustration of an example embodiment of an end effector 103 of a wire-handling tool 100 according to various embodiments. In some examples, the end effector 103 can be formed in a C-shape instead of the S-shape shown in FIGS. 1A-7. According to various examples, the rear facing hook 106 and the front facing hook 109 can be located on the same side (C-shape shown in FIG. 8), the opposite side (S-shape shown in FIGS. 1A-7), or other configurations rotating about the axis of the elongated rod 123. The end effector 103 can include notches 136 in any of the configurations. For example, the end effector 103 in the C-shape configuration of FIG. 8 can include one or more notches 136 in either the front facing hook 109, the rear facing hook 106, and/or both.

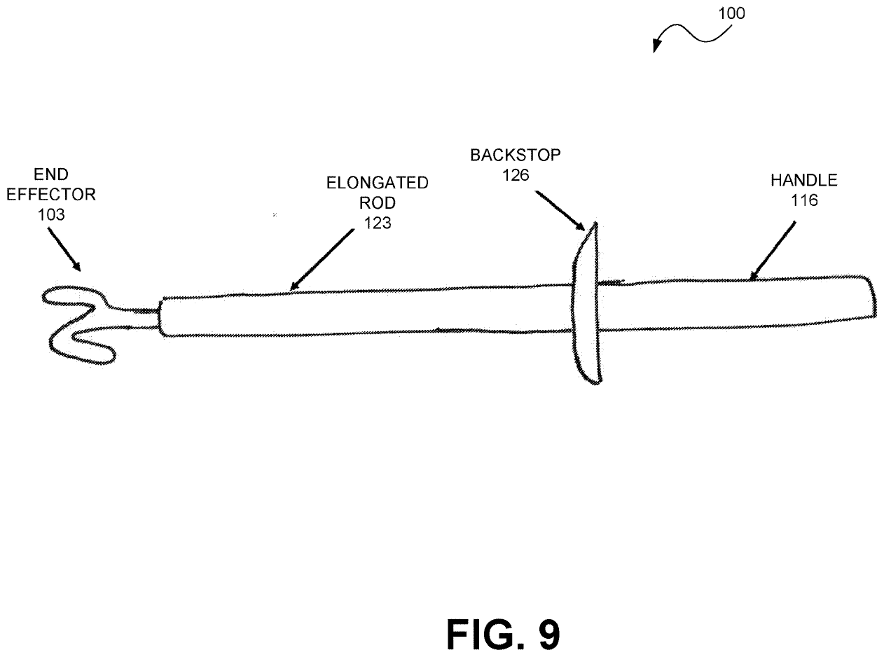

Moving to FIG. 9, shown is an illustration of an example embodiment of a wire-handling tool 100 according to various embodiments. In some embodiments, as shown in FIG. 9, the wire-handling tool 100 does not have the forearm cuff 119 of FIGS. 1A-1C and 3-6. The wire-handling tool 100 can have a backstop 126 which extends circumferentially around the elongated rod 123. The backstop 126 can have a curved shape such that when an operator is gripping the handle 116, the backstop 126 curves at least partially over the hand of the operator in order to provide additional protection from the hazardous wire. While the illustration of FIG. 9 depicts one embodiment, combination embodiments of the various features described herein are also contemplated within this disclosure. For example, a curved backstop 126 as shown in FIG. 9 is capable of attachment to any of the wire-handling tools 100 described herein. Additionally, the removal of the forearm cuff 119 can be accomplished in any of the embodiments described herein and coupled with a variety of backstop 126 shapes and designs.

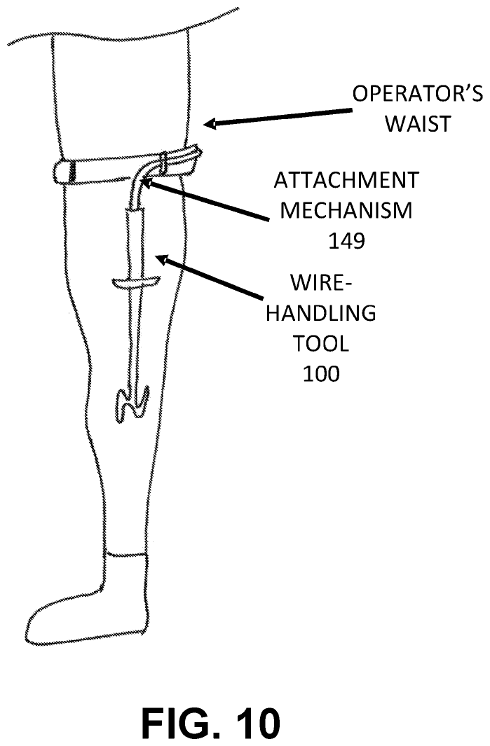

At FIG. 10, shown is an illustration of an example embodiment of a wire-handling tool 100 according to various embodiments. According to various examples, a wire-handling tool 100 can further comprise a strap, belt, belt attachment, or other attachment mechanism 149 disposed at the proximal end of the wire-handling tool 100 in order to attach to an operator's person or uniform. As shown in FIG. 10, the attachment mechanism 149 can comprise a stretchable, elastic, spring-loaded or other form extendable cord which can be attached to an operator's waist. When attached to an operator's waist, the wire-handling tool 100 is ready to deploy as needed and requires less effort in transporting the tool from place to place. In some embodiments, the attachment mechanism 149 can comprise specialized hooks, loops, pockets, holsters, etc. which are added to the wire-handling tool 100 in order to keep the wire-handling tool 100 on the person of the operator.

Illustrative examples of various embodiments of the present disclosure are set forth below. Additional embodiments of the present disclosure are discussed in the preceding paragraphs. Accordingly, the scope of the present disclosure should not be construed as being limited to the following clauses:

### Clause 1

A device for handling hazardous wire, comprising an end effector portion configured to contact hazardous wire, the end effector portion comprising a rear facing hook and a front facing hook; a handle portion comprising a handle suitable to grasp the device; and an elongated rod having a length, the elongated rod extending along an axis from the handle portion at a proximal end to the end effector portion at a distal end.

### Clause 2

The device of clause 1, further comprising an adjustable backstop coupled to the elongated rod between the end effector portion and the handle portion, the adjustable backstop configured to be adjustably positioned along at least a portion of the length of the elongated rod.

### Clause 3

The device of clause 2, wherein the adjustable backstop is rotatable about the elongated rod.

### Clause 4

The device of clause 1, wherein the elongated rod has an adjustable length or is telescoping.

### Clause 5

The device of clause 1, wherein the elongated rod is foldable.

### Clause 6

The device of clause 1, wherein the handle is positioned at an angle relative to the axis of the elongated rod.

### Clause 7

The device of clause 1, wherein the handle portion comprises a forearm cuff positioned proximal to the handle.

### Clause 8

The device of clause 1, wherein the end effector portion further comprises a notch feature incorporated into at least one of the rear facing hook or the front facing hook.

### Clause 9

The device of clause 1, wherein the end effector portion further comprises a moveable lever to open or close at least one of the rear facing hook or the front facing hook, the moveable lever operable by a user from the handle portion.

### Clause 10

The device of clause 1, wherein the rear facing hook and the front facing hook form an S-shape.

### Clause 11

The device of clause 1, wherein the rear facing hook and the front facing hook form a C-shape.

### Clause 12

The device of clause 1, wherein the end effector is removeable, and the device further comprising a connector portion suitable to secure the end effector to the elongated rod.

### Clause 13

The device of clause 1, wherein the elongated rod comprises a metal or composite material.

### Clause 14

The device of clause 1, further comprising a backstop that extends circumferentially around the elongated rod.

### Clause 15

The device of clause 1, wherein the handle extends along the axis of the elongated rod.

### Clause 16

The device of clause 14, wherein the backstop is connected to the handle by an arch-like structure.

### Clause 17

A wire-handling tool, comprising an elongated rod having a proximal end and a distal end; an end effector connected to the elongated rod at the distal end, the end effector comprising a rear facing hook and a front facing hook; and a backstop disposed on the elongated rod proximal to the end effector, the backstop configured to shield a handle disposed near the proximal end of the elongated rod.

### Clause 18

The wire-handling tool of clause 17, wherein the backstop is configured in a frustum shape, where a larger end of the frustum shape is proximal to a narrower end.

### Clause 19

The wire-handling tool of clause 17, wherein the end effector is detachably attached to the distal end of the elongated rod.

### Clause 20

A wire-handling tool, comprising an elongated rod having a proximal end and a distal end; an end effector connected to the elongated rod at the distal end, the end effector comprising a rear facing hook and a front facing hook; a backstop disposed on the elongated rod proximal to the end effector; and a handle disposed on the elongated rod proximal to the backstop, the handle being connected to the backstop by an arched member.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A device for handling hazardous wire, comprising:
an end effector portion configured to contact hazardous wire, the end effector portion comprising a rear facing hook and a front facing hook;
a handle portion comprising a handle suitable to grasp the device; and
an elongated rod having a length, the elongated rod extending along an axis from the handle portion at a proximal end to the end effector portion at a distal end.

2. The device of claim 1, further comprising an adjustable backstop coupled to the elongated rod between the end effector portion and the handle portion, the adjustable backstop configured to be adjustably positioned along at least a portion of the length of the elongated rod.

3. The device of claim 2, wherein the adjustable backstop is rotatable about the elongated rod.

4. The device of claim 1, wherein the elongated rod has an adjustable length or is telescoping.

5. The device of claim 1, wherein the elongated rod is foldable.

6. The device of claim 1, wherein the handle is positioned at an angle relative to the axis of the elongated rod.

7. The device of claim 1, wherein the handle portion comprises a forearm cuff positioned proximal to the handle.

8. The device of claim 1, wherein the end effector portion further comprises a notch feature incorporated into at least one of the rear facing hook or the front facing hook.

9. The device of claim 1, wherein the end effector portion further comprises a moveable lever to open or close at least one of the rear facing hook or the front facing hook, the moveable lever operable by a user from the handle portion.

10. The device of claim 1, wherein the rear facing hook and the front facing hook form an S-shape.

11. The device of claim 1, wherein the rear facing hook and the front facing hook form a C-shape.

12. The device of claim 1, wherein the end effector is removeable, and the device further comprising a connector portion suitable to secure the end effector to the elongated rod.

13. The device of claim 1, wherein the elongated rod comprises a metal or composite material.

14. The device of claim 1, further comprising a backstop that extends circumferentially around the elongated rod.

15. The device of claim 1, wherein the handle extends along the axis of the elongated rod.

16. The device of claim 14, wherein the backstop is connected to the handle by an arch-like structure.

17. A wire-handling tool, comprising:
an elongated rod having a proximal end and a distal end;
an end effector connected to the elongated rod at the distal end, the end effector comprising a rear facing hook and a front facing hook; and
a backstop disposed on the elongated rod proximal to the end effector, the backstop configured to shield a handle disposed near the proximal end of the elongated rod.

18. The wire-handling tool of claim 17, wherein the backstop is configured in a frustum shape, where a larger end of the frustum shape is proximal to a narrower end.

19. The wire-handling tool of claim 17, wherein the end effector is detachably attached to the distal end of the elongated rod.

20. A wire-handling tool, comprising:
an elongated rod having a proximal end and a distal end;
an end effector connected to the elongated rod at the distal end, the end effector comprising a rear facing hook and a front facing hook;
a backstop disposed on the elongated rod proximal to the end effector; and
a handle disposed on the elongated rod proximal to the backstop, the handle being connected to the backstop by an arched member.
